(19) United States
(12) Patent Application Publication
(10) Pub. No.: US 2007/0076790 A1
(43) Pub. Date: Apr. 5, 2007

(54) Method and apparatus for testing a network using a spare receiver

(76) Inventors: Brian K. Thibeault, Attleboro, MA (US); Poth Boontor, Somerville, MA (US); Ching-Ho Cheng, Allston, MA (US); Thomas R. Keske, Randolph, MA (US); Veronica M. Lobo, Sharon, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/240,296

(22) Filed: Sep. 30, 2005

(51) Int. Cl. H04L 5/16; H04B 17/00

(52) U.S. Cl. 375/222; 375/224

(57) ABSTRACT

A spare receiver in a CMTS is used to non-invasively test the upstream signal quality of a network without disrupting a subscriber's operations. A modem registered with a receiver on the network is selected as a testing modem. The spare receiver is RF connected to the receiver and the testing modem is tuned to the spare receiver. The testing modem is used to test the signal quality of the network, such as by using a SNR test. The testing modem remains registered with the network during the testing operation. Other modems are prevented from registering with the spare receiver. If other modems attempt to register on the spare receiver, the system overrides their attempts and moves them back to another receiver. The testing modem is returned to its original receiver when testing is completed.

### FIELD OF THE INVENTION

This invention relates to testing a network using a spare receiver without interruption of service. This invention more particularly relates to borrowing a modem from a receiver to test the signal quality of a network using a spare receiver.

### BACKGROUND

Coaxial cable television systems have been in widespread use for many years and extensive networks have been developed. The extensive and complex networks are often difficult for a cable operator to manage and monitor. Particularly, a typical cable network generally contains a headend which provides content to a cable modem termination system (CMTS) containing several receivers, each receiver is usually connected to modems of many subscribers, e.g., a single receiver may be connected to hundreds of modems. In many instances the operator will cable multiple receivers together to serve a particular area of a town or city.

Cable networks are also increasingly carrying signals which require a high quality and reliability of service, such as voice communications or Voice over IP (VoIP) communications. Any disruption of voice or data traffic is a great inconvenience and often unacceptable to a subscriber. Various factors may affect the quality of service, including the quality of the upstream channels.

Whenever the CMTS detects that the frequency a receiver is currently using has communication problems, such as having high noise levels, a cable operator may move one or more modems to a different receiver. Cable operators often use Load Balancing Groups to equalize the load of the traffic across receivers, and Spectrum Groups to allocate multiple upstream frequencies to a receiver. In order to have receivers belong to the same Load Balancing Group or Spectrum Group they must be physically connected together. Multiple frequencies in a Spectrum Group may be used for frequency agility. The CMTS can determine which “backup” frequency is the best to use and retune the receiver in the Spectrum Group to the new frequency with no interruption to cable subscribers.

However, it is often difficult for a CMTS to detect communication problems prior to mass deregistration of modems, which may result in significant service disruption to subscribers.

### SUMMARY

This invention allows testing of a cable network using a spare receiver and a selected modem registered on a primary receiver.

The invention performs non-intrusive testing, avoiding a disruption of service to subscribers.

An apparatus for testing a network in accordance with the principles of the invention may comprise: a plurality of receivers, each receiver being capable of receiving signals according to predetermined communication protocols from a plurality of modems; a switching unit which selectively connects the spare receiver to a signal line associated with one of the plurality of receivers, enabling the spare receiver to receive signals sent to a selected one of the plurality of receivers from a modem registered with the selected one of the plurality of receivers; and a controller configured to select a modem registered on a receiver of the plurality of receivers as a testing modem, to tune the testing modem to the spare receiver, and perform testing of the network using the testing modem.

In an apparatus of the invention, the controller may be further configured to instruct the spare receiver to receive signals using a predetermined communication protocol of a first selected receiver of the plurality of receivers and to instruct the switching unit to connect the spare receiver to another selected receiver of the plurality of receivers.

In an apparatus of the invention, a load balancing manager may be associated with the controller and configured to instruct the testing modem to tune to the spare receiver.

In an apparatus of the invention, the controller may be further configured to send initial maintenance or station maintenance messages to the testing modem.

In an apparatus of the invention, the controller may be further configured to prevent other modems from registering on the spare receiver.

In an apparatus of the invention, the controller may be configured to move the testing modem back to the receiver of the plurality of receivers after the testing of the network.

A method of testing a network having a plurality of receivers and a spare receiver may comprise the steps of: connecting the spare receiver to a signal line associated with another receiver of the plurality of receivers; selecting a modem registered on the other receiver as a testing modem; moving the testing modem to register with the spare receiver; and performing testing operations on the network with the modem and the spare receiver.

In a method of the present invention, the modem may be selected as a testing modem if no current voice communications are passing through the modem.

In a method of the present invention, the step of moving the testing modem to communicate with the spare receiver includes the steps of: tuning the testing modem to the spare receiver; and sending at least one of an initial maintenance or a station maintenance message to the testing modem.

A method of the present invention may further include the step of determining if the testing modem is providing a ranging message to the spare receiver.

A method of the present invention may further include the step of preventing other modems from registering on the spare receiver.

A computer readable medium containing instructions for a processor to perform a method of testing a network having a plurality of receivers and a spare receiver comprising the steps of: connecting the spare receiver to a signal line associated with another receiver of the plurality of receivers; selecting a modem registered on the other receiver as a testing modem; moving the testing modem to register with the spare receiver; and performing testing operations on the network with the modem and the spare receiver.

In a computer readable medium of the present invention, the modem may be selected as a testing modem if no current voice communications are passing through the modem.

In a computer readable medium of the present invention, the step of moving the testing modem to communicate with the spare receiver includes the steps of: tuning the testing modem to the spare receiver; and sending at least one of an initial maintenance or a station maintenance message to the testing modem.

A computer readable medium of the present invention may further include instructions to perform the step of determining if the testing modem is providing a ranging message to the spare receiver.

A computer readable medium of the present invention may further include instructions to perform the step of preventing other modems from registering on the spare receiver.

Those of skill in the art will appreciate that the present invention enables performing testing, such as Signal to Noise Ratio measurements, on non-active spare spectrum. The testing can be performed without any loss of service for data or voice because the modem is on the spare receiver, and the testing does not affect any of the active receivers. The present invention enables the cable operator to be able to measure channel quality without time constraints or loss of service. Any range of (or single) frequencies may be diagnosed for a cable operator to get a picture of their RF plant. The present invention could also be used to help locate low noise (clean) areas of the spectrum where the operator could place high speed data or VoIP modems for data passing. Another benefit may to use the spare receiver to check the quality of spare spectrum which may be switched to whenever an active frequency goes bad.

### BRIEF DESCRIPTION OF THE DRAWINGS

FIG. 1 illustrates an exemplary architecture of a CMTS in accordance with the principles of the invention.

FIG. 2 illustrates an exemplary configuration for connecting a spare receiver in an exemplary CMTS in accordance with the principles of the invention.

FIG. 3 illustrates an exemplary processing unit in accordance with the principles of the invention.

FIG. 4 illustrates an exemplary flow diagram of an exemplary process for borrowing a modem for testing according to the principles of the invention.

### DETAILED DESCRIPTION OF THE DRAWINGS

The spare receiver, or 9th receiver in an eight receiver unit, in accordance with the principles of the invention, allows analysis of channel quality without disruption of voice (VoIP) or data traffic on the active receivers. In order to get the best analysis of the channel, the signal to noise ratio (SNR) metric may be used for testing, but those of skill in the art will appreciate that any appropriate testing technique may be used.

In order to perform testing of the SNR, data must be passed on a cable modem in the network. The spare receiver is not normally used for registering modems so a single modem is borrowed from one of the primary receivers. Once the modem is on the spare receiver, it may be used to pass data and retrieve testing values, such as SNR values. However, other modems are preferably not allowed to be registered on the spare receiver during a testing operation as these may interfere with the testing process. Once the testing process is completed, the “borrowed” modem is preferably returned to its original primary receiver.

In the preferred implementation, a borrowed a cable modem (the testing modem) may be used to perform a variety of tests, such as SNR measurements, on any specific frequency or range of frequencies selected by cable operators. The testing can be performed without any loss of service for data or voice because the modem is on the spare receiver, and the testing does not affect any of the active receivers. The present invention enables the cable operator to be able to measure channel quality without time constraints or loss of service.

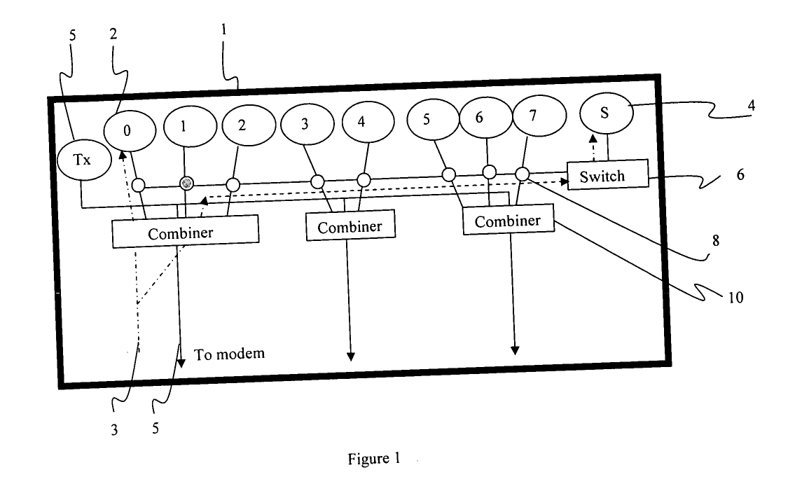

FIG. 1 illustrates an exemplary CMTS 1 with primary receivers 2 (R0-R7), which may be a Motorola BSR64000 CMTS. A transmitter unit 5 is also illustrated which serves to transmit signals to modems of the users (not shown) via signal path 5 and combiner 10. Transmitter unit 5 may be a single transmitter or multiple transmitters. Those of skill in the art will appreciate that transmitter unit 5 preferably transmits to the modems according to predetermined communication protocols, such as Data Over Cable Systems Interface Specification (DOCSIS) protocols.

While eight receivers are shown, those of skill in the art will appreciate that any number of receivers may be used. In the exemplary illustration, receivers R0, R1 and R2 are in one Load Balancing Group, receivers R3 and R4 are in another group and R5, R6 and R7 are in the last group. The spare receiver 4, illustrated as a 9^{th} receiver, can preferably tap into any one receiver R0-R7, at a time and, in the example of FIG. 1, is tapped into receiver 1 via tap 8. Combiner 10 receives signals from user modems and provides them to receivers 2 (R0-R7). Dotted line 3 depicts the return path that a response from a cable modem (not shown) to receiver R0 would take in the exemplary implementation of FIG. 1. Those of skill in the art will appreciate that the CMTS is used generally to refer to any suitable modem termination system, that the architecture illustrated is exemplary and any type of cabling (connections) may be used, such as coaxial wires, optical fibers, twisted pairs, and wireless connections.

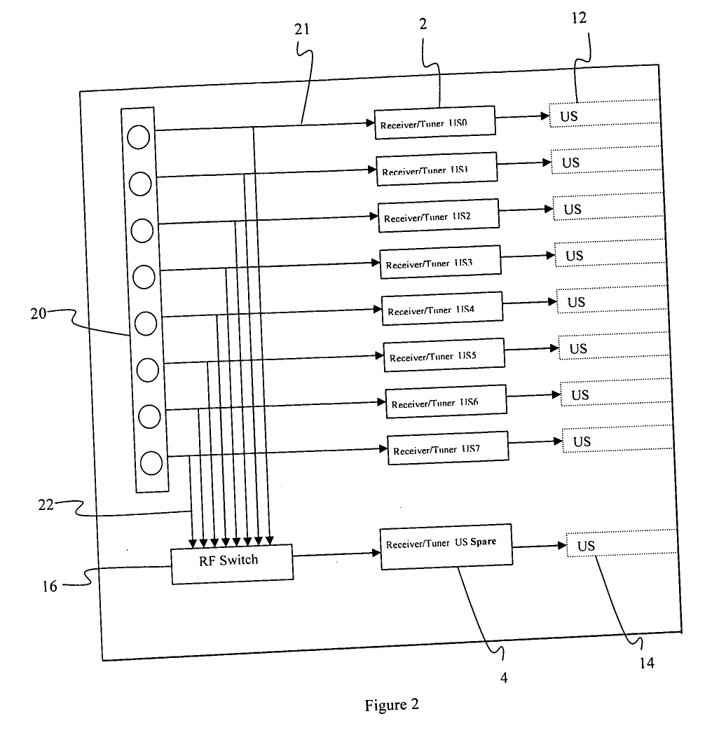

FIG. 2 illustrates the spare receiver 4 tapped into each of primary receiver ports 2 (e.g. R0-R7) in a non-intrusive manner. As illustrated, CMTS receiver ports 20, which may be in the form of Amphenol connectors, are provided to allow cables, e.g. coaxial cables, (not shown) to be connected with primary receivers 2. As also illustrated, signals from the headend are preferably provided through ports 20 to receivers 2 and demodulators 12.

Spare receiver 4 preferably taps into signal lines 21 of primary receiver ports 20 via signal lines 22, and the taps are preferably located where the cable signal comes from receiver ports 20 into the receivers 2 so both the connected primary receiver 2 and the spare receiver 4 may receive the same signal. Those of skill in the art will appreciate that each of the primary receivers 2 (e.g. receivers R0-R7) receive signals according to different communication characteristics, e.g. communication on a different frequency (RF band) and communication protocols. Spare receiver 4 is preferably tunable to the RF bands of each of the primary receivers 2. Preferably, the spare receiver 4 connects (matrices) with only one primary receiver 2 at a time.

When a cable operator initiates a testing operation they may select any registered modem of their choice or the CMTS may select the modem for them. Once the modem has been selected it is moved (tuned to the frequency of the spare receiver and registered with the spare receiver) the spare receiver testing data is passed to it and the results are measured. Once the testing measurements are completed the modem is moved back (instructed to retune to frequency of the primary receiver) to its original primary receiver. This whole process is preferably performed without deregistering the modem from the network to avoid disrupting the subscriber's service.

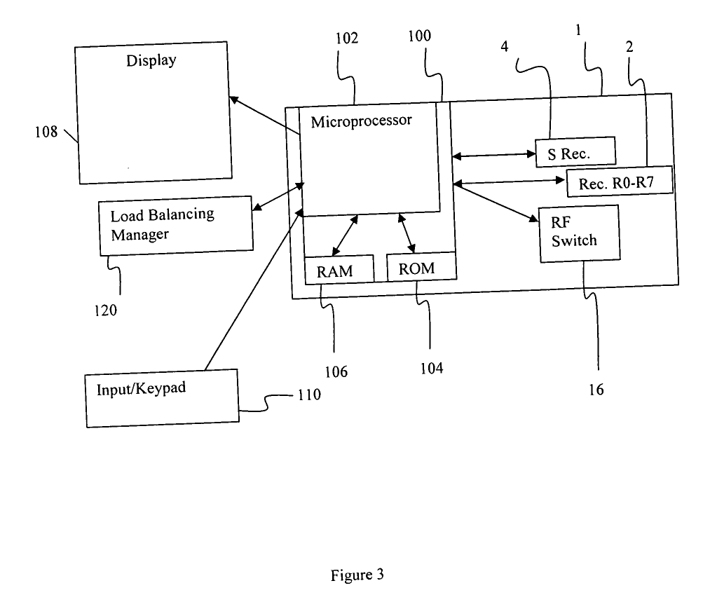

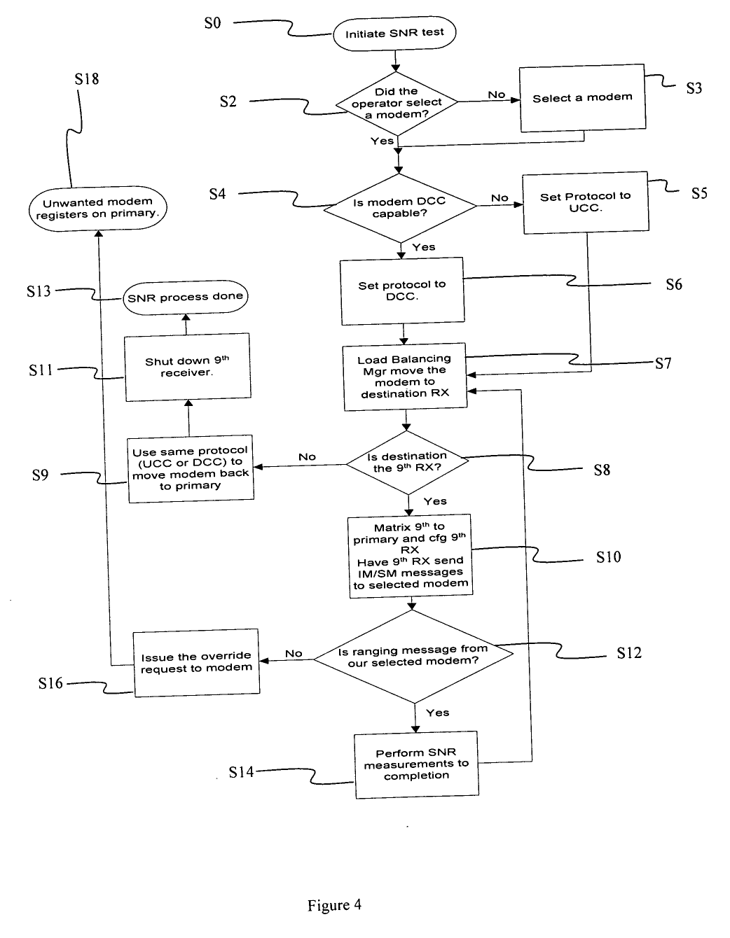

FIG. 3 illustrates an exemplary processing unit 100 contained in the CMTS. Processing unit 100 preferably contains a microprocessor 102 which may receive information, such as instructions and data, from a ROM 104 or RAM 106. Processing unit 100 is preferably connected to a display 108, such as a CRT or LCD display, which may display status information such as whether a receiver is in the same Load Balancing Group or Spectrum Group as another selected primary receiver. An input keypad 110 may also be connected to processing unit 100 and may allow an operator to provide instructions, processing requests and/or data to processor 100. Microprocessor 102 is preferably configured to provide instructions to RF switch 16 (FIG. 2) to select a primary receiver and modem borrowed in accordance with the processes illustrated in FIG. 4. Microprocessor 102 is also preferably configured to configure spare receiver 4 to match the communication characteristics of the selected primary receiver. The communication characteristics of each receiver 2 may be stored on ROM 104 or RAM 106, or may be provided from an external source, such as the headend. RAM 104 and/or ROM 106 may also carry instructions for microprocessor 102 to perform the processes illustrated in FIG. 4.

A load balancing manager module 120 also preferably operates with microprocessor 102. The load balancing manager module 120 may be a software implementation running within microprocessor 102 or may be operated on another component connected to microprocessor 102. Microprocessor 102 preferably is configured to select an appropriate modem for use as a testing modem and to determine the type of modem and protocols associated with moving the selected testing modem to the spare receiver.

FIG. 4 illustrates an exemplary process to determine the signal quality of the upstream channel with a CMTS in accordance with the principles of the invention. As illustrated in FIG. 3, a channel quality test, such as a signal to noise ratio (SNR) test is initiated to start the process, step S0. The cable operator may select a testing modem to use in the test, step S2, YES or the modem may be selected by a processor in the CMTS, step S2, No. If the testing modem is automatically selected by the CMTS, step S3, the CMTS preferably locates a good idle modem, for example, the CMTS may determine if an identified target modem is currently registered on a primary receiver, and determine if there is a voice call in progress on the modem. If the identified target modem is registered and no voice calls are currently in progress, then the modem may be selected as the testing modem for the testing operation. The CMTS may also determine if the target modem is currently passing data, and select a modem which is also not current passing data as the testing modem.

Once the testing modem is identified, the process determines if the testing modem can be moved to the spare receiver by a dynamic channel change (DCC), step S4. This may be determined while determining if the modem is registered with a primary receiver by determining what type of modem it is, e.g. a 1.0, 1.X or a 2.0 modem. A determination of an ability to be moved via DCC may be made based on the modem type. If the testing modem is capable of being moved via DCC, the protocols for moving the testing modem via DCC are set, step S6. If the testing modem is not capable of being moved via DCC, step S4, NO, then the testing modem may be moved using an upstream channel change (UCC), and the protocol for performing a UCC operation are set, step S5.

The selected testing modem is moved to the destination receiver, step S7, which is preferably the spare receiver, step S8, YES. In a preferred embodiment, the spare receiver is matriced (connected) to the primary receiver associated with the testing modem and a load balancing manager (software task) may be used to move the testing modem to the spare receiver, step S10. A message may be sent from microprocessor 102 (FIG. 3) to the load balancing manager 120 instructing the load balancing manager to pass the protocol to be used (UCC or DCC) to the testing modem. The load balancing manager 120 preferably issues the UCC or DCC message to the modem sending it the ID of the spare receiver as its destination and/or sending initial maintenance (IM) and station maintenance (SM) requests. Once the modem retunes to the spare receiver it is determined whether the testing modem is ranging correctly on the spare receiver, step S12. Preferably, the both the channel width and the frequency of the modem are not changed at the same time since some cable modems cannot handle this and will deregister. Preferably, the primary receiver information is stored by microprocessor 102 so the process can return the testing modem to its original primary receiver when the testing is finished. Once it is determined that the testing modem has successfully moved to the spare receiver, step S12, YES, the testing, such as SNR measurements, may be performed and the results saved by microprocessor 102.

During the moving process (and all the while it is registered on the spare receiver) the CMTS preferably sends to the testing modem both IM and SM messages to keep it registered on the spare receiver. During this time it is possible for any modem connected to the RF of the primary receiver of the testing modem to register on the spare receiver because the spare receiver is tapped into the primary receiver's RF signals. To prevent other unwanted modems from registering on the spare receiver an upstream override process may be performed on these modems to redirect them to the primary receiver or another receiver. Preferably, the only modem allowed to be registered on the spare receiver during a testing operation is the testing modem.

At the completion of the testing, the process is preferably reversed and the load balancing task moves (instructs the modem to retune to frequency of its original receiver) the testing modem back to its original receiver using the same protocol used to move it to the spare receiver. Once the testing modem is back on its original receiver the testing process is finished.

Those of skill in the art will appreciate that since the active receivers are not required to be used for testing, the process illustrated in FIG. 4 is non-intrusive to the cable network, and may be performed without causing a loss or disruption of service to subscribers. Even voice calls over the cable network should not be affected by any of the testing described above. The process in FIG. 4 may be performed periodically by a cable operator, e.g. once per week, every 24 hours, etc., and may also be initiated by a service call indicating problems or indicating a change in the cable network.

The processes in FIG. 4 may be implemented in hard wired devices, firmware or software running in a processor. A processing unit for a software or firmware implementation is preferably contained in the CMTS. The processes illustrated in FIG. 4 may be contained on a computer readable medium which may be read by microprocessor 102. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Those of skill in the art will appreciate that the present invention enables performing testing, such as Signal to Noise Ratio measurements, on non-active spare spectrum. By doing so numerous value added features can be performed for the operators. For example, any range of (or single) frequencies may be diagnosed for a cable operator to get a picture of their RF plant. The present invention could also be used to help locate low noise (clean) areas of the spectrum where the operator could place high speed data or VoIP modems for data passing. Another benefit may be to use the spare receiver to check the quality of spare spectrum which may switched to whenever an active frequency goes bad.

Those of skill in the art will appreciate that other modifications may be implemented without departing from the scope and spirit of the invention. For example, a plurality of testing procedures may be used with the borrowed modem, and a plurality of modems may be borrowed to repeat a testing procedure.

1. An apparatus for testing a network comprising:
a plurality of receivers, each receiver being capable of receiving signals according to predetermined communication protocols from a plurality of modems;
a switching unit which selectively connects the spare receiver to a signal line associated with one of the plurality of receivers, enabling the spare receiver to receive signals sent to a selected one of the plurality of receivers from a modem registered with the selected one of the plurality of receivers; and
a controller configured to select a modem registered on a receiver of the plurality of receivers as a testing modem, to register the testing modem to the spare receiver, and perform testing of the network using the testing modem.

2. The apparatus of claim 1, wherein the controller is further configured to instruct the spare receiver to receive signals using a predetermined communication protocol of a first selected receiver of the plurality of receivers and to instruct the switching unit to connect the spare receiver to another selected receiver of the plurality of receivers.

3. The apparatus of claim 1, wherein an inactive modem is selected as the testing modem.

4. The apparatus of claim 1, further comprising a load balancing manager associated with the controller and configured to instruct the testing modem to tune to the spare receiver.

5. The apparatus of claim 1, wherein the controller is further configured to send initial maintenance or station maintenance messages to the testing modem.

6. The apparatus of claim 1, wherein the controller is further configured to prevent other modems from registering on the spare receiver.

7. The apparatus of claim 1, wherein the testing modem remains registered on the network.

8. The apparatus of claim 1, wherein the controller is configured to move the testing modem with the receiver of the plurality of receivers after the testing of the network.

9. A method of testing a network having a plurality of receivers and a spare receiver comprising the steps of:
connecting the spare receiver to a signal line associated with another receiver of the plurality of receivers;
selecting a modem registered on the other receiver as a testing modem;
registering the testing modem to communicate with the spare receiver; and
performing testing operations on the network with the modem and the spare receiver.

10. The method of claim 9, wherein the modem is selected as a testing modem if no current voice communications are passing through the modem.

11. The method of claim 9, wherein the step of registering the testing modem to communicate with the spare receiver includes the steps of:
tuning the testing modem to the spare receiver; and
sending at least one of an initial maintenance or a station maintenance message to the testing modem.

12. The method of claim 9, further including the step of determining if the testing modem is providing a ranging message to the spare receiver.

13. The method of claim 9, wherein testing operation determines a signal to noise ratio measurements on the network.

14. The method of claim 9, wherein the testing modem remains registered on the network.

15. The method of claim 9, further comprising the step of preventing other modems from registering with the spare receiver.

16. A computer readable medium containing instructions for a processor to perform a method of testing a network having a plurality of receivers and a spare receiver comprising the steps of:
connecting the spare receiver to a signal line associated with another receiver of the plurality of receivers;
selecting a modem registered on the other receiver as a testing modem;
registering the testing modem to communicate with the spare receiver; and
performing testing operations on the network with the modem and the spare receiver.

17. The computer readable medium of claim 16, wherein the modem is selected as a testing modem if no current voice communications are passing through the modem.

18. The computer readable medium of claim 16, wherein the step of registering the testing modem to communicate with the spare receiver includes the steps of:
tuning the testing modem to the spare receiver; and
sending at least one of an initial maintenance or a station maintenance message to the testing modem.

19. The computer readable medium of claim 16, further comprising instructions to perform the step of determining if the testing modem is providing a ranging message to the spare receiver.

20. The computer readable medium of claim 16, wherein signal to noise ratio measurements on the network.

21. The computer readable medium of claim 16, wherein the testing modem remains registered on the network.

22. The computer readable medium of claim 16, further comprising instructions to perform the step of preventing other modems from registering with the spare receiver.
